(19) United States
(12) Patent Application Publication
(10) Pub. No.: US 2005/0099402 A1
(43) Pub. Date: May 12, 2005

(54) Touch panel and liquid crystal display apparatus using the same

(76) Inventors: Akira Nakanishi, Hirakata-shi (JP); Shigeyuki Fujii, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/967,268

(22) Filed: Oct. 19, 2004

(30) Foreign Application Priority Data
Nov. 6, 2003 (JP) 2003-376865
Jan. 8, 2004 (JP) 2004-002722

(51) Int. Cl. G09G 5/00

(52) U.S. Cl. 345/173

(57) ABSTRACT

The touch panel has a structure such that a projection portion is provided on a second transparent substrate and a flexible printed-circuit board is bonded by thermocompression to the projection portion. By allowing width of a picture frame to be smaller in other portions than the projection portion, downsizing and a lighter weight of a touch panel-carrying apparatus can be attained. By bonding a sheet member such as a polarizing plate to a top face of the second transparent substrate excluding an area of the projection portion, stress to be applied from the sheet member to the thermocompression-bonding portion of the FPC is reduced and, therefore, electric connection stability of the FPC can be enhanced.

### TECHNICAL FIELD

The present invention relates to a touch panel which is provided on the side of a display surface of a liquid crystal display apparatus or the like and can input a specified signal by pressing the surface corresponding to a displayed content with a pen or a finger, and also relates to a liquid crystal display apparatus provided with the touch panel.

### BACKGROUND OF THE INVENTION

In recent years, in portable apparatuses or electronic apparatuses which require menu selections, the number of apparatuses which mount a touch panel and can input a specified signal corresponding to a displayed content by pressing with a pen or a finger is increasing.

Among many types of touch panels, an analog-type touch panel comprising a resistive film which has been mainly used is explained with reference to Japanese Patent Laid-Open Application No. 2002-132449 using accompanying drawings.

In order to facilitate understanding of a structure of the touch panel, the structure is illustrated with a size expanded in the thickness-direction.

FIGS. 10 and 11 are drawings for explaining a conventional touch panel. The conventional touch panel comprises first transparent substrate 1 and first transparent electrically conductive film 3 made of indium-tin oxide (hereinafter, referred to also as “ITO”) or the like formed on an entire top face of first transparent substrate 1 by sputtering, for example. First transparent substrate 1 is formed from a rectangular glass plate, a rectangular polycarbonate sheet or an acrylic resin sheet, or a plastic film such as a biaxially oriented polyethylene terephthalate film or polycarbonate resin film which are processed into rectangular forms.

In FIG. 10, visible area boundary 6 of the touch panel is shown by a broken line. On first transparent electrically conductive film 3 inside visible area boundary 6, small dot spacers 5 made of an electrically insulating epoxy resin or the like are provided at specified intervals.

When first transparent substrate 1 is a flexible film, substrate 1 may be laminated on a bottom face of substrate 1 with a resin sheet such as the polycarbonate resin sheet or the acrylic resin sheet, or a glass sheet as a support mean.

Second transparent electrically conductive film 4 made of ITO or the like is formed by sputtering on an entire bottom face of second transparent substrate 2 which corresponds to the operating side of the touch panel. In order to allow second transparent electrically conductive film 4 and first transparent electrically conductive film 3 to be opposed to each other with a specified interval inside visible area boundary 6, first transparent substrate 1 and second transparent substrate 2 are bonded to each other in picture frame form at a portion outside visible area boundary 6.

In order to protect the touch panel from a scratch or the like which is liable to occur when it is operated by a pen or a finger, hard coat layer 7 having a pencil hardness of 3H made of acrylic resin is provided on the side of a top face of second transparent substrate 2.

In an area outside visible area boundary 6, a wiring portion and electrode (hereinafter, referred to also as “wiring/electrode pattern”) 8 for supplying a voltage to first transparent electrically conductive film 3, undercoat resist 9 and overcoat resist 10 are formed; further, wiring/electrode pattern 12 for supplying a voltage to second transparent electrically conductive film 4, undercoat resist 13 and overcoat resist 14 are formed; and still further, adhesive layer 11 is formed in a pattern for bonding first transparent substrate 1 and second transparent substrate 2. On this occasion, wiring/electrode patterns 8 and 12 are formed by first preparing an electrically conductive paint in which silver powder is dispersed in a resin and, then, printing and drying the thus-prepared paint. Resists 9, 13, 10 or 14 are formed for insulating portions which are not necessary to be electrically connected of wiring/electrode patterns 8 and 12.

FIG. 11 shows a structure in which transparent electrically conductive films 3 and 4 of first transparent substrate 1 and second transparent substrate 2 respectively are not etched in a pattern. In the structure, undercoat resist 9 is formed between wiring/electrode pattern 8 and first transparent electrically conductive film 3, while undercoat resist 13 is formed between wiring/electrode pattern 12 and second transparent electrically conductive film 4.

On the other hand, when a transparent electrically conductive film is formed in a pattern only in a necessary portion so that a portion such as a wiring portion where electrical connection of each of wiring/electrode patterns 8 and 12 is not required overlaps none of transparent electrically conductive films 3 and 4, undercoat resists 9 and 13 can be omitted.

A flexible printed-circuit board (hereinafter, referred to also as “FPC”) as shown in FIG. 11 transmits an output signal from each of first transparent electrically conductive film 3 and second transparent electrically conductive film 4 to an external circuit (not shown) and a tail portion thereof is connected to the external circuit.

FPC 15 involves substrate film 16, plurality of wiring patterns 17, on substrate film 16, formed by a metal-plated copper foil or by a cured film of an electrically conductive paste in which silver powder is dispersed, and cover lay 18 to cover a portion which is unnecessary for being exposed, for example, on a middle portion of wiring pattern 17. FPC 15 is connected to second transparent substrate 2 via anisotropic electrically conductive film 16 by means of thermocompression bonding. Wiring patterns 17 of FPC 15 thus subjected to the thermocompression bonding are electrically connected to any one of wiring/electrode patterns 8 and 12.

In FIG. 11, the touch panel in which FPC 15 is bonded by thermocompression only to second transparent substrate 2 is shown. However, as shown in FIGS. 12 to 15, a case in which FPC 21 of a double-sided wiring type is used is known. A structure thereof is briefly described below.

As shown in FIG. 12, FPC 21, which is interposed between first transparent substrate 1 and second transparent substrate 2, has cut 211 in the center thereof. A left half of FPC 21 from cut 211 is fixed to second transparent substrate 2, while a right half of FPC 21 from cut 211 is fixed to first transparent substrate 1. FIG. 13 shows a cross-sectional view taken along line A-A explaining a fixed state of FPC 21 and second transparent substrate 2, while FIG. 14 shows a cross-sectional view taken along line B-B explaining a fixed state of FPC 21 and first transparent substrate 1. The conventional touch panel as shown in FIG. 13 is an example in which FPC 21 is bonded by thermocompression onto second transparent substrate 2 via anisotropic electrically conductive film 22, while the conventional touch panel as shown in FIG. 14 is an example in which FPC 21 is bonded onto first transparent substrate 1 by thermocompression via anisotropic electrically conductive film 23. Wiring pattern 24 formed on a bottom face of FPC 21 is electrically connected to wiring/electrode 8 of first transparent substrate 1 via anisotropic electrically conductive film 23, while it is connected to wiring pattern 24 on a top face thereof by means of through-hole electrode 25. By taking such structure as described above, on the side of the tail portion, wiring pattern 24 connected to first transparent electrically conductive film 3 and wiring pattern 26 (see FIG. 13) connected to second transparent electrically conductive film 4 are collected on the top face of FPC 21 and, then, are connected to an external circuit.

In the conventional touch panel, there is a case in which a polarizing plate or a circularly polarizing plate is applied on second transparent substrate 2 and there is a strong demand for improving optical characteristics thereof. Japanese Patent Laid-Open Application No. 2001-34418 discloses a touch panel provided with a polarizing plate attached with a quarter-wave plate polarizer. The touch panel provided with the polarizing plate attached with the quarter-wave plate polarizer is now described with reference to FIGS. 15 to 17.

In the touch panel as shown in FIGS. 15 to 17, in order to reduce reflection of external light, polarizing plate 27 attached with a quarter-wave plate polarizer is provided on an entire surface of second transparent substrate 2 via transparent adhesive layer 28 and hard coat layer 29 is provided on a top face of polarizing plate 27.

In the conventional touch panel using FPC 21 of the double-sided wiring type, FPC 21 is connected to second transparent electrically conductive film 4 which becomes an input operation side via anisotropic electrically conductive film 22 and polarizing plate 27 is provided on a top face of second transparent substrate 2 including an area to which FPC 21 is bonded by thermocompression.

In the conventional touch panel, an area is required for bonding FPC 15 or FPC 21 on at least one of first transparent substrate 1 and second transparent substrate 2 by thermocompression. As shown in FIGS. 10, 12 and 15, the area corresponds to W0×H0, where W0 is a width and H0 is a length. It has been in a mainstream to design such that only the length H0 of a rectangular substrate of each of first transparent substrate 1 and second transparent substrate 2 is expanded to such an extent as necessary for providing FPC 15 and FPC 21 thereon.

However, in the aforementioned conventional touch panel, an area outside visible area boundary 6 of the touch panel, namely, an area of the picture frame, becomes large and, accordingly, there is a problem in that it becomes difficult to reduce a size and weight of an apparatus on which the touch panel is mounted.

Further, as shown in FIGS. 15 to 17, in the conventional touch panel attached with polarizing plate 27, polarizing plate 27 is laminated on an entire face of second transparent substrate 2 including a portion thereof to which FPC 21 is bonded by thermocompression. For this account, in a high temperature atmosphere, a high temperature and high humidity atmosphere or a thermal shock test atmosphere, stress to be generated by a curling property or thermal expansion/contraction of polarizing plate 27 is likely to be transmitted to a portion to which FPC 21 is bonded by thermocompression. There is a problem in that the stress becomes a force for peeling FPC 21 bonded onto both first transparent substrate 1 and second transparent substrate 2 off therefrom and it becomes difficult to consistently maintain electrical connection of a portion thus bonded by thermocompression of FPC 21.

In order to relax the stress and the like, a structure in which cut is provided on FPC 21 or another structure in which a sheet having a small thermal expansion coefficient for preventing curling is further provided on polarizing plate 27 including an area of the picture frame has been proposed. However, in any one of the thus-proposed structures, there is a problem in that, although an influence to the portion to which the FPC is bonded by thermocompression is reduced, a restriction on a design of wiring pattern is caused or another problem in that a production cost is increased.

### SUMMARY OF THE INVENTION

A touch panel according to the present invention comprises a first transparent substrate having a first transparent electrically conductive film formed on a top face thereof, a second transparent substrate, having a second transparent electrically conductive film formed on a face opposite to the first transparent electrically conductive film, in which an outside of a visible area boundary is fixed by a adhesive layer and an inside thereof is held with a specified space from the first transparent substrate, and a flexible printed-circuit board (FPC) bonded by thermocompression to at least one of the first transparent substrate and the second transparent substrate. Further, at least one of the first transparent substrate and the second transparent substrate has a projection portion to which the FPC is bonded by thermocompression. Still further, the touch panel can be prepared at a low cost such that width of a frame thereof excluding the projection portion can be set narrow and, accordingly, have an effect which can contribute to reduction of a size and weight of an apparatus in which the touch panel is mounted. Furthermore, an apparatus in which the touch panel according to the present invention is mounted on the liquid crystal display device can realize down-sizing of a liquid crystal display apparatus.

### BRIEF DESCRIPTION OF THE DRAWINGS

FIG. 1 is a top plan view of a touch panel as a first embodiment according to the present invention;

FIG. 2 is a cross-sectional view taken along line A-A of FIG. 1;

FIG. 3 is a top plan view of a touch panel as a second embodiment according to the present invention;

FIG. 4 is a cross-sectional view taken along line A-A of FIG. 3;

FIG. 5 is a cross-sectional view taken along line B-B of FIG. 3;

FIG. 6 is a perspective diagram showing a liquid crystal display apparatus of a third embodiment according to the present invention;

FIG. 7 is a cross-sectional view taken along line A-A of FIG. 6;

FIG. 8 is a perspective diagram showing a liquid crystal display apparatus of a fourth embodiment according to the present invention;

FIG. 9 is a cross-sectional view taken along line A-A of FIG. 8;

FIG. 10 is a top plan view of a conventional touch panel;

FIG. 11 is a cross-sectional view taken along line A-A of FIG. 10;

FIG. 12 is a top plan view of another configuration of an FPC in a conventional touch panel;

FIG. 13 is a cross-sectional view taken along line A-A of FIG. 12;

FIG. 14 is a cross-sectional view taken along line B-B of FIG. 12;

FIG. 15 is a top plan view of a touch panel attached with a conventional circularly polarizing plate;

FIG. 16 is a cross-sectional view taken along line A-A of FIG. 15; and

FIG. 17 is a cross-sectional view taken along line B-B of FIG. 15.

### DESCRIPTION OF THE INVENTION

A touch panel according to the present invention has a structure such that a flexible printed-circuit board (hereinafter, referred to also as “FPC”) for transmitting a led-out signal to an external circuit is bonded using thermocompression to a projection portion provided on at least one of a first transparent substrate and a second transparent substrate which constitute the touch panel. The touch panel can reduce width of a picture frame excluding the projection portion, can realize a low cost and, accordingly, can contribute to reduction of a size and weight of an apparatus on which the touch panel is mounted.

Further, the touch panel according to the present invention has a structure such that a sheet member is applied on a top face of the second transparent substrate excluding the projection portion bonded with an FPC in thermocompression manner. Still further, since the touch panel according to the present invention has a structure such that, as fixing of the FPC using thermocompression is performed in the projection portion, not only it can contribute to the reduction of the size and weight of the apparatus on which it is mounted but also the sheet member is not lapped on the projection portion, a stable electric connection can be maintained even in a high temperature atmosphere, a high temperature and high humidity atmosphere or a thermal shock test atmosphere. For example, when the sheet member is a polarizing plate or a circularly polarizing plate, the touch panel of the present invention prevents stress caused by a curling or a deformation by thermal expansion/contraction from being transmitted to a portion bonded with the FPC using thermocompression, accordingly, the touch panel according to the present invention can realize an article excellent in environmental resistance features at low cost.

When a polarizing plate, a circularly polarizing plate, an anti-reflection film, a hard coat film, a colored film or an indicating film is used as the sheet member, a function of each film can be added, to thereby realize a multi-functional touch panel having a high performance.

In the touch panel according to the present invention, since an entire width of the FPC is fixed using thermocompression on a projection portion in the second transparent substrate which becomes an operating side, fixation of the FPC is stabilized. Further, since the touch panel has a structure such that a portion subjected to the thermocompression bonding is the projection portion, when the thermocompression bonding is performed in a large area, an influence of transmission of overheat or pressure to a adhesive layer which bonds substrates to each other and fixes them can be suppressed. Therefore, the touch panel can reduce occurrence of undulation within a visible area of the second transparent substrate which requires flexibility.

In a liquid crystal display apparatus provided with the touch panel according to the present invention, a size of an external shape of an approximate rectangle of each of the first transparent substrate and the second transparent substrate excluding respective projection portions is allowed to be same with or less than that of a liquid crystal display device. For this account, the touch panel according to the present invention not only can contribute to reduction of size and weight of an apparatus on which a liquid crystal display apparatus attached with the touch panel (hereinafter, referred to also as “TTP-LCD”) but also has an action of contributing to improvement of reliability of environmental resistance features or the like or a cost reduction of the apparatus.

In the liquid crystal display apparatus provided with the touch panel according to the present invention, the touch panel is provided on all surface of at least a liquid crystal display area on a top face of the liquid crystal display device. The present invention can reduce size and weight of an apparatus and improve environmental resistance features. As air at an interface between the touch panel and the liquid crystal display device is eliminated, an apparatus in which a reflection of light at the interface is reduced and visibility is excellent can be realized.

In the liquid crystal display apparatus provided with the touch panel according to the present invention, the touch panel in which the polarizing plate or a circularly polarizing plate is used as a sheet member is provided on all surface of at least a liquid crystal display area on a top face of the liquid crystal display device. On this occasion, the liquid crystal display device itself does not require an upper polarizing plate. Namely, since an air layer is not present at an interface between the touch panel and the liquid crystal display device and the number of the polarizing plate as the TTP-LCD is reduced by one, the liquid crystal display apparatus can further reduce reflection of light and, accordingly, brightness of the liquid crystal display is improved and the visibility is further enhanced.

Under these circumstance, according to the present invention, a low cost touch panel having a structure in which width of the picture frame area, excluding a projection portion which is a portion provided with the FPC, is allowed to be narrow can be prepared. The touch panel as described above can contribute to reduction of size and weight of an apparatus on which the touch panel is mounted. Further, by bonding the sheet member such as the polarizing plate to a portion excluding an area of the projection portion, a detrimental effect to a portion bonded with the FPC due to deformation of the sheet member thus provided is reduced, to thereby realize favorable environmental resistance features. Namely, as an entire apparatus, there is a favorable effect in that the TTP-LCD which is inexpensive and has a favorable reliability and an excellent visibility can be realized.

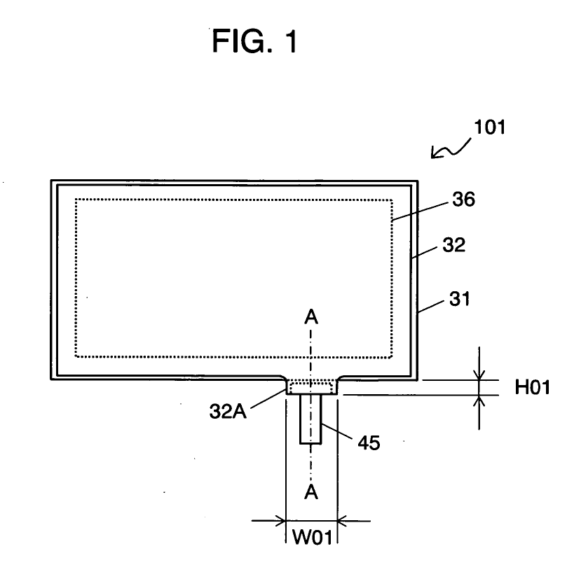

Embodiments according to the present invention are described with reference to FIGS. 1 to 9 below. In order to facilitate understanding of a structure, the structure is illustrated with a size expanded in the direction of thickness.

### Embodiment 1

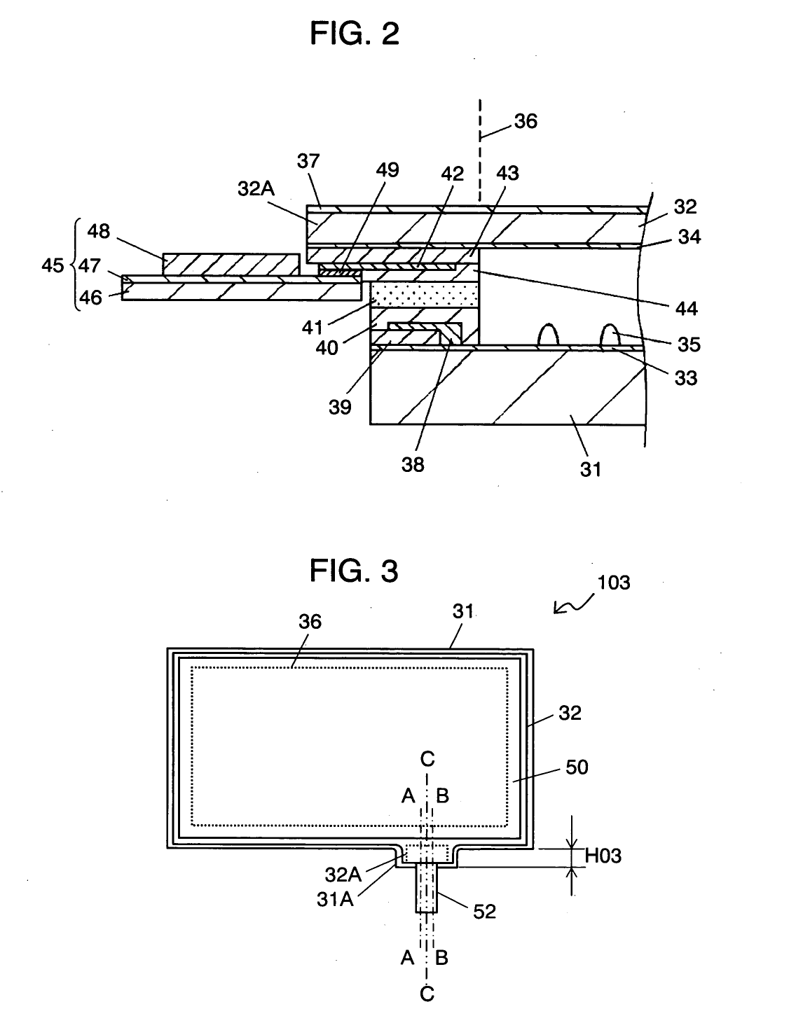

FIGS. 1 and 2 are views explaining touch panel 101 according to a first embodiment of the present invention.

Touch panel 101 comprises first transparent substrate 31 made of soda glass processed in an approximately rectangular shape, second transparent substrate 32 having flexibility made of a biaxially oriented polyethylene terephthalate film having a thickness of 188 μm on the operational side and flexible printed-circuit board (hereinafter, referred to also as “FPC”) 45.

First transparent electrically conductive film 33 made of indium tin oxide (hereinafter, referred to also as “ITO”) is formed on an entire top face of first transparent substrate 31 and, further, small dot spacers 35 formed from insulating epoxy resin or the like are disposed at specified intervals on first transparent electrically conductive film 33 inside visible area boundary 36 shown by a dotted line.

Second transparent substrate 32 comprises second transparent electrically conductive film 34 made from ITO and formed on an entire bottom face thereof. In an area inside visible area boundary 36 of the touch panel, a space between first electrically conductive film 33 and second transparent electrically conductive film 34 is maintained to be in the range of from about 20 μm to 500 μm and, outside visible area boundary 36, first transparent substrate 31 and second transparent substrate 32 are bonded to each other.

Second transparent substrate 32 has oblong projection portion 32A projecting outward from a middle portion of a side thereof processed in an approximately rectangular shape and a size of the approximately rectangular shape is almost same with that of first transparent substrate 31.

First transparent substrate 31 and second transparent substrate 32 are bonded to each other such that outer circumferential portions of rectangular shapes of respective transparent substrates are lapped one on the other in frame form. Namely, projection portion 32A of second transparent substrate 32 is configured such that it is projected from rectangular-shaped portions of first transparent substrate 31 and second transparent substrate 32.

In order to protect the touch panel from a scratch or the like which is liable to occur when it is operated by a pen or a finger, hard coat layer 7 having a pencil hardness of 3H made of an acrylic resin is provided on the side of a top face of second transparent substrate 32.

In an area outside visible area boundary 36, wiring portion and electrode for providing voltage to transparent electrically conductive films 33 and 34 (hereinafter, referred to also as “wiring/electrode pattern”) 38 and 42 are formed by first preparing an electrically conductive paint in which silver powder is dispersed in a resin and, then, printing and drying the thus-prepared paint. In wiring/electrode patterns 38 and 42, in order to aim at insulating a portion which does not require an electrical connection, undercoat resists 39 and 43 and overcoat resists 40 and 44 are each formed in a pattern state.

Wiring/electrode pattern 42 of second transparent substrate 32 extends outwardly to projection portion 32A and an end portion thereof is exposed on a surface thereof for obtaining an electric connection.

Although not shown, wiring/electrode pattern 38 on the side of first transparent substrate 31 is led out on the side of second transparent substrate 32 and extends to projection portion 32A in a same manner as in wiring/electrode pattern 42 and an end portion thereof is exposed on a surface thereof.

Adhesive layer 41 for bonding first transparent substrate 31 and second transparent substrate 32 to each other is also formed in an area outside visible area boundary 36 in frame or picture frame form.

Flexible printed-circuit board (hereinafter, referred to also as “FPC”) 45 for transmitting a led-out signal from first transparent electrically conductive film 33 and second transparent electrically conductive film 34 to an external circuit comprises base film 46 made of polyimide and a plurality of wiring patterns 47 which are each constituted by a gold-plated copper foil on base film 46, and a portion unnecessary of exposure of wiring pattern 47 is covered by cover lay 48 made of polyimide.

FPC 45 is bonded using thermocompression to a bottom face of projection portion 32A of second transparent substrate 32 via anisotropic electrically conductive film 49 involving, as a main component, an epoxy resin in which gold-plated resin beads are dispersed, and the tail portion thereof is connected to an external circuit (not shown).

In wiring pattern 47, wiring/electrode patterns 42 and 38 thereof extend outwardly to- projection portion 32A and electrically connected to an exposed end portion via anisotropic electrically conductive film 49.

When connecting the tail portion of FPC 45 to the external circuit, projection portion 32A of second transparent substrate 32 has flexibility and, accordingly, workability thereof is excellent. Further, since FPC 45 having no cut can be used, a cost increase of the FPC itself does not occur.

As Embodiment 1, when FPC 45 is thermocompression bonded with the entire width thereof onto projection portion 32A in second transparent substrate 32 which becomes the operation side, the bonding of the FPC is stabilized. Further, since a portion subjected to the thermocompression bonding is restricted to projection portion 32A, it is possible to put an restraint on an occurrence in which heating and pressure application at the time of thermocompression bonding give an influence to adhesive layer 41 which bonds first transparent substrate 31 and second transparent substrate 32 to each other and fixes them. Therefore, second transparent substrate 32 which requires flexibility can reduce occurrence of an undulation within the visible area and, accordingly, a touch panel of high quality can be obtained.

A method for manufacturing the touch panel according to the present Embodiment 1 is briefly described below.

Firstly, first transparent electrically conductive film 33 made of ITO is formed on a surface of first transparent substrate 31 by a sputtering technique.

At the same time, a paint containing, as a main component, an acrylic resin is applied so as to form hard coat layer 37 on one face of second transparent substrate 32 by using a roll coater and second transparent electrically conductive film 34 made of ITO is formed on the reverse face thereof by sputtering.

Then, dot spacer 35 is formed in a portion inside visible area boundary 36, while undercoat resists 39 and 43, wiring/electrode patterns 38 and 42, overcoat resists 40 and 44, adhesive layer 41 and the like are formed in respective specified patterns in a portion outside visible area boundary 36 by screen-printing.

After each layer is formed, scribing in a touch panel size and in a substantially rectangular shape is conducted and, then, cutting is performed, to thereby prepare first transparent substrate 31 made of glass. At the same time, punching-out in a shape in which projection portion 32A which becomes a portion to be bonded using thermocompression of FPC 45 is projected from a side of an approximately rectangular shape outward in an oblong shape is performed, to thereby prepare second transparent substrate 32 made of a polyethylene terephthalate film.

Next, a single piece of first transparent substrate 31 and that of second transparent substrate 32 processed in respective specified shapes are bonded to each other by adhesive layer 41 formed in an area outside visible area boundary 36 such that first transparent electrically conductive film 33 and second transparent electrically conductive film 34 faces to each other. Further, after a step of putting pressure on the outer circumferential portion for strengthening adhesion of the outside of visible area boundary 36 or a step of aging for stabilizing a surface flatness is performed, FPC 45 is bonded and fixed using thermocompression to projection portion 32A of second transparent substrate 32 via anisotropic electrically conductive film 49.

By such thermocompression bonding, wiring pattern 47 is not only connected to first transparent electrically conductive film 33 via wiring/electrode pattern 38 but also electrically connected to second transparent electrically conductive film 34 via wiring/electrode pattern 42.

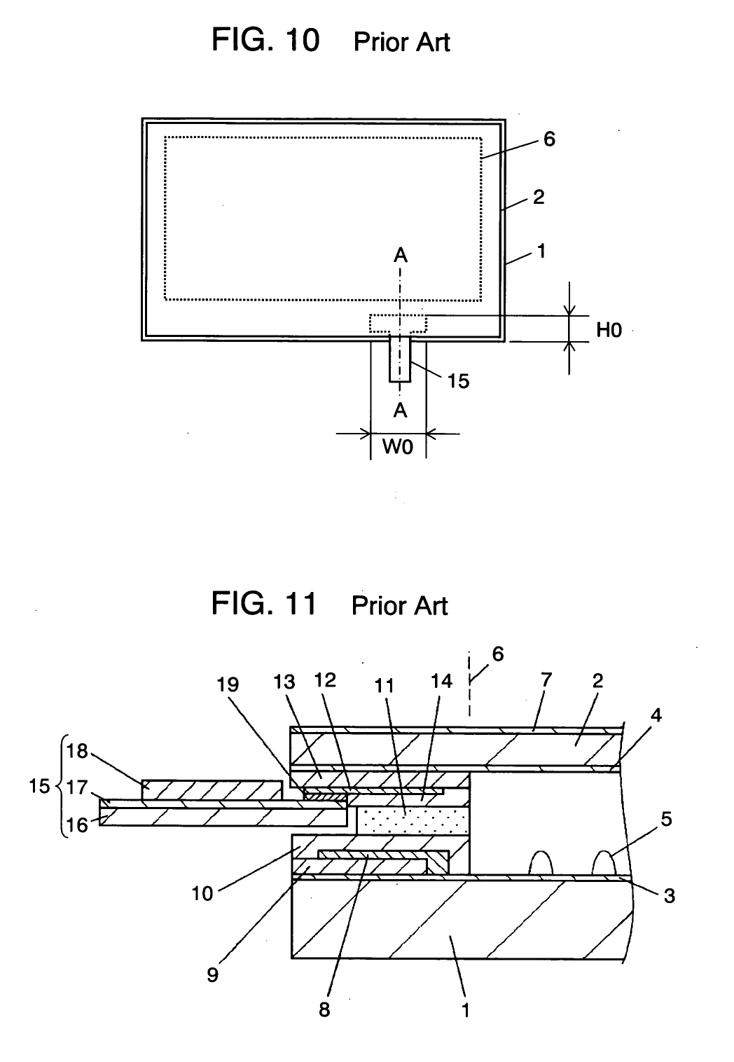

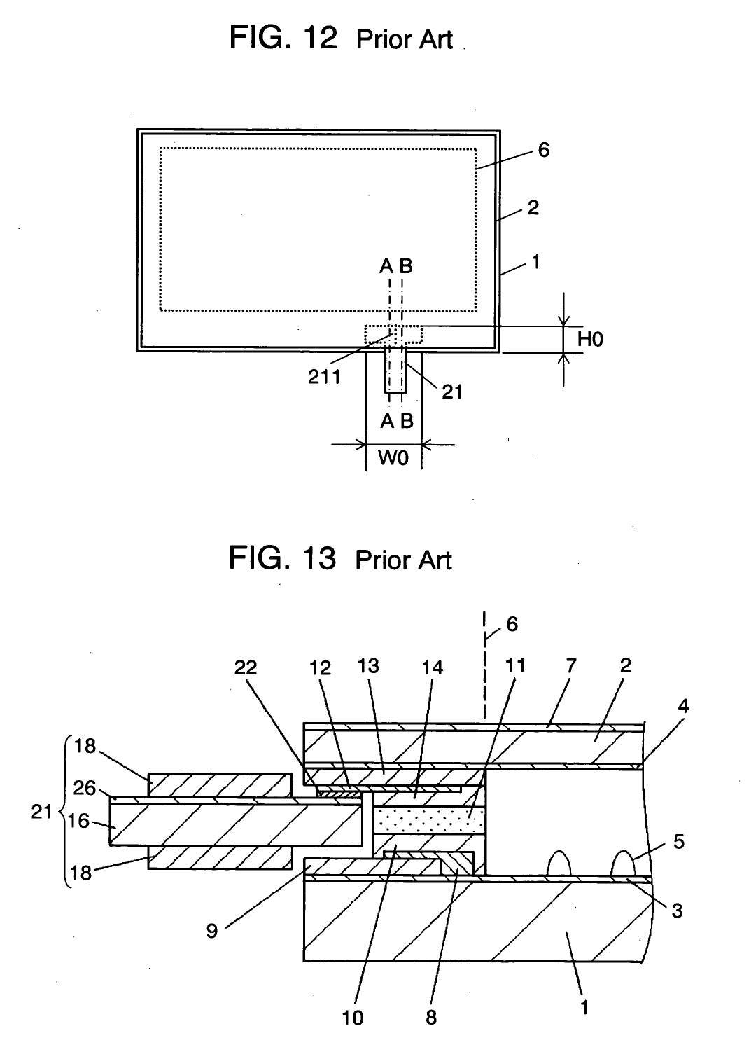

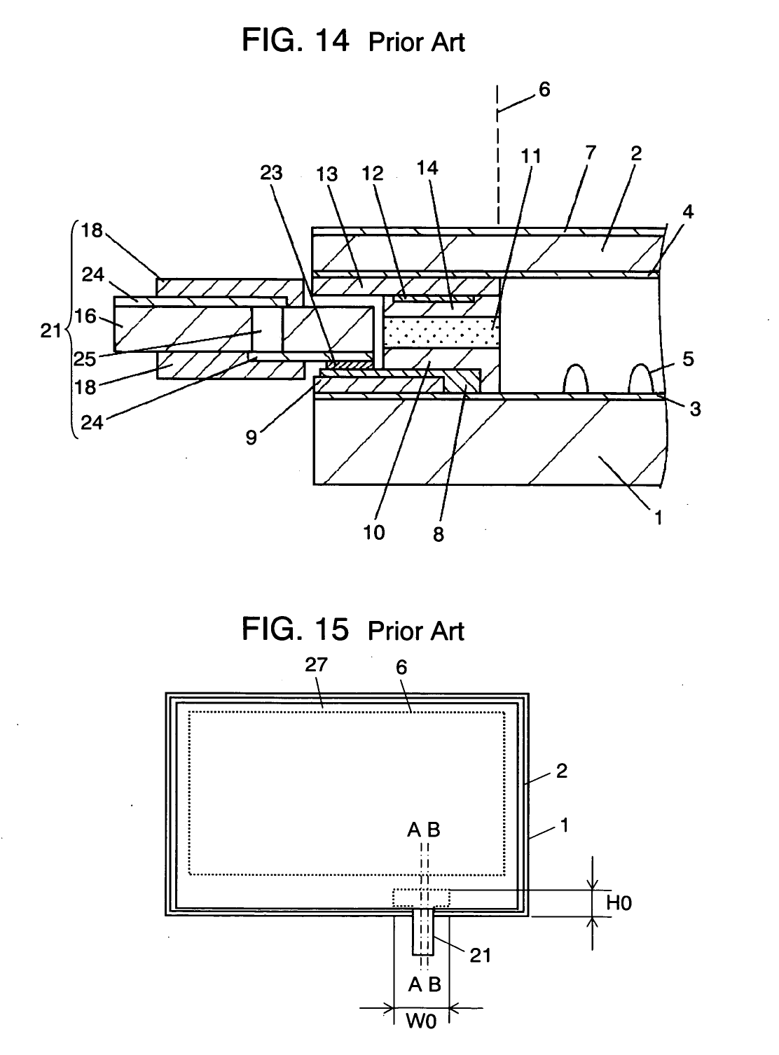

As has been described above, touch panel 101 according to the present Embodiment 1 is characterized in that FPC 45 is thermocompression bonded and connected to projection portion 32A of second transparent substrate 32. In one side of substrate 32 on which FPC 45 is bonded using thermocompression, compared with the conventional touch panel as shown in FIGS. 10 and 11, an area corresponding to size H0 of length of the FPC as shown in FIG. 10 excluding projection portion 32A can be reduced and, accordingly, a configuration of a narrow picture frame specification in which width of the picture frame of the side is narrow can be realized.

For example, as shown in FIG. 1, touch panel 101 according to the present Embodiment 1 can aim at reduction of the area corresponding to H01=3 mm at a bottom side excluding the projection portion having a width of W01 and, also in an apparatus on which the touch panel is mounted, reduction of the size thereof corresponding to a portion on which the touch panel is mounted can be realized.

Next, an operation of touch panel 101 according to the present Embodiment 1 is briefly described.

When a pressing operation is performed from above second transparent substrate 32 at a specified position by using a finger or a pen, second transparent substrate 32 is locally bent downward around the position subjected to the pressing operation as a center and, then, first transparent electrically conductive film 33 and second transparent electrically conductive film 35 come into contact with each other. A voltage ratio at a contact point is led out via FPC 45 and, then, the resultant signal is detected by an external circuit, to thereby judge the position subjected to the pressing operation. In other positions than that subjected to the pressing operation, first transparent electrically conductive film 33 and second transparent electrically conductive film 34 are restricted by dot spacer 35 and maintain a non-contact state therebetween.

As described above, touch panel 101 according to the present Embodiment 1 has a structure such that projection portion 32A projecting outward from a rectangular portion of second transparent substrate 32 is provided as an area in which FPC 45 is to be bonded and, then, FPC 45 is thermocompression bonded to projection portion 32A and allows the picture frame to be configured with a small width in other portions than projection portion 32A and, also, can contribute to reduction of the size and weight of the apparatus on which the touch panel is mounted.

Since touch panel 101 according to the present Embodiment 1 has a structure by using the FPC having no cut, a material cost can be reduced by narrowed portions of the picture frames of substrates 31 and 32, to thereby aim at cost reduction.

As for first transparent substrate 31, besides soda glass, a resin sheet, a film such as a biaxially oriented film or a polycarbonate film or the like formed by processing a polycarbonate resin, a methacrylic resin, a polycycloolefin resin, a polycyclohexadiene resin, a norbornene resin or the like by means of extrusion molding, casting or injection molding may be used. Thickness thereof is in the range of from 0.1 mm to 10 mm and, as practical one, preferably in the range of from 0.15 mm to 3 mm.

When the film such as the biaxially oriented film or the polycarbonate film is used, glass or a resin sheet formed by processing a polycarbonate resin, a methacrylic resin, a polycycloolefin type resin, a polycyclohexadiene type resin, a norbornene resin or the like by means of extrusion molding, casting molding or injection molding may be laminated as a supporting body.

Projection portion 32A can be provided only on second transparent substrate 32, only on the first transparent substrate 31 or on both of the first transparent substrate and the second transparent substrate, and, then, FPC 45 can be bonded.

In these cases, when the aforementioned resin sheet or film, or such sheet or film bonded with a supporting body made of a resin sheet on a face opposite to the face on which first transparent electrically conductive film 33 is formed is used as the first transparent substrate, any of these sheets and films can easily be processed in a shape having the projection portion by die-punching using a metallic mold or laser-cutting; therefore, such usages are extremely effective.

As for second transparent substrate 32, an oriented film selected from the biaxially oriented polyethylene terephthalate, biaxially oriented polyethylene naphthalate and uniaxially oriented polyethylene terephthalate can be used, and a polycarbonate film or polycycloolefin film prepared by a casting can also be used. Thickness of these films is in the range of from 0.01 mm to 0.4 mm and practically in the range of from 0.025 mm to 0.2 mm.

As for first transparent electrically conductive film 33 and second transparent electrically conductive film 34, besides ITO, tin oxide (SnO₂), zinc oxide (ZnO), a thin film of gold (Au), a thin film of silver (Ag) and the like can be used. As for methods for forming these films, besides sputtering, CVD (chemical vapor deposition), vacuum deposition, ion plating, application-sintering of a metallic organic substance and the like may be used.

As for materials of undercoat resists 39 and 43, overcoat resists 40 and 44, besides the epoxy resin and the acrylic resin, a polyester resin, a urethane resin, a phenolic resin and the like can be used. It is important to choose a material having an excellent adhesion to a printing surface.

As for wiring/electrode patterns 38 and 42, besides the composition involving silver powder and the polyester resin, a mixture of silver powder and carbon powder, copper powder and metal powder, as electrically conductive powder, may be used. Further, as a resin component thereof, a resin favorable in electric resistance, adhesiveness, dispersibility of electrical conductive powder, environmental resistance and the like can appropriately be selected from among an epoxy resin, a phenolic resin, an acrylic resin, a urethane resin and the like.

As for methods for forming undercoat resists 39 and 43, overcoat resists 40 and 44, wiring/electrode patterns 38 and 42 and adhesive layer 41, a printing method such as off-set printing, pattern-printing using a printer head and the like can be used. Further, adhesive layer 41 can be formed such that a pressure sensitive adhesive double coated tape is cut in a pattern and applied.

As for base film 46 of FPC 45 and cover lay 48, materials such as polyethylene terephthalate and the like can be used. As for wiring pattern 47, besides the gold-plated copper foil, a solder-plated copper foil or a cured film of an electrically conductive paste in which silver powder or the like is dispersed in a curable resin can be used.

As for the main component of anisotropic electrically conductive film 49, besides the epoxy resin, an acrylic resin and the like can be used and, further, besides the gold-plated resin beads, solder-plated resin beads, ceramic beads and metallic particles can be used.

### Embodiment 2

FIGS. 3 to 5 are views explaining a touch panel according to Embodiment 2 of the present invention. Parts having same structures as those in Embodiment 1 are marked with same references and will not be described in detail.

Touch panel 103 according to Embodiment 2 includes first transparent substrate 31 on which first transparent electrically conductive film 33 is formed, second transparent substrate 32 on which second electrically conductive film 34 is formed and FPC 52.

Touch panel 103 according to Embodiment 2 has a structure such that first transparent substrate 31 and second transparent substrate 32 are both made of a polycarbonate film; and first transparent substrate 31 has projection portion 31A and second transparent substrate 32 has projection portion 32A. In order to obtain an optical isotropy, the polycarbonate film is produced by a casting method.

FPC 52 is a double-sided wiring type which has wiring patterns 53 and 54 on top and bottom faces of a portion to which transparent electrically conductive films 33 and 34 are connected.

Wiring pattern 54 on the side of the bottom face thereof is, as shown in FIG. 5, led out to the side of the top face via through-hole 55 and, on the side of a tail portion (for example, the left-hand side in FIG. 5), wiring patterns (53 and) 54 are collected on the side of the top face.

FPC 54 also uses such inexpensive one which does not have a cut or the like between a portion on which wiring pattern 53 connecting to transparent electrically conductive films 33 is provided and a portion on which wiring pattern 54 connecting to transparent electrically conductive films 34 is provided.

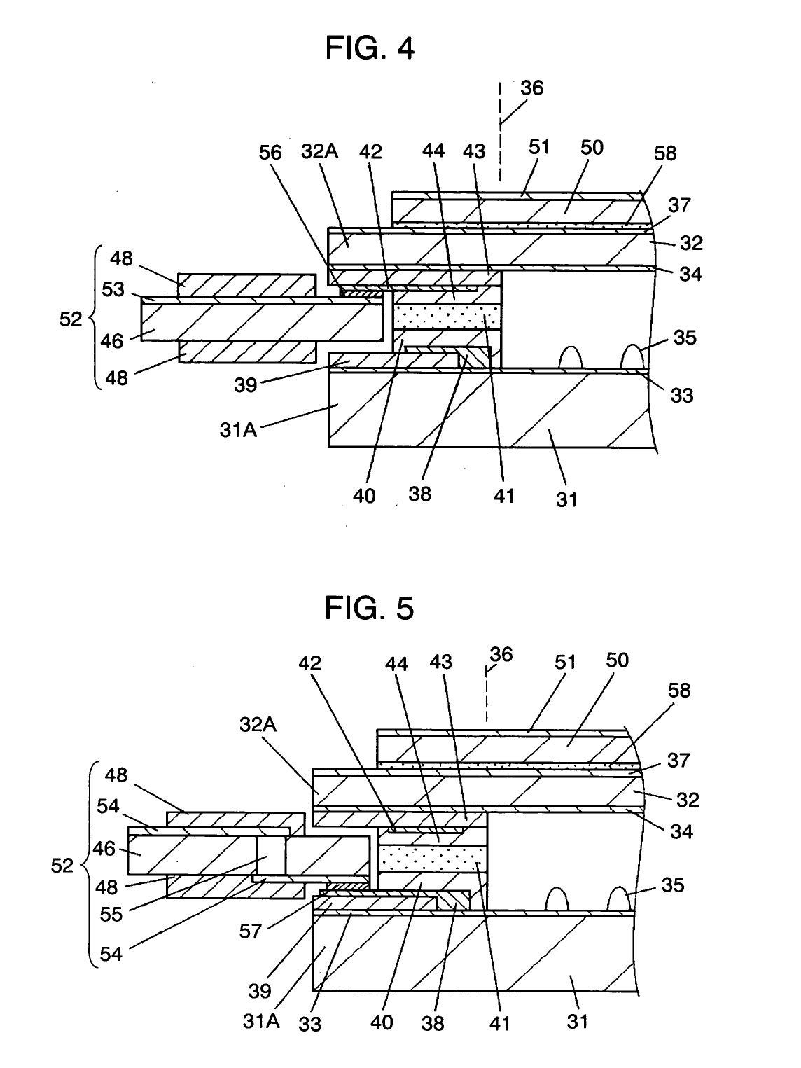

FPC 52 is, as shown in FIGS. 4 and 5, connected in a state in which it is interposed between a bottom face area of projection portion 32A of second transparent substrate 32 and a top face area of projection portion 31A of first transparent substrate 31. As shown in FIG. 3, at a portion of FPC 52 at which it is interposed between projection portion 32A and projection portion 31A, half of FPC 52 in the left-hand side from line C-C is fixed on second transparent substrate 32 while half of FPC 52 in the right-hand side from line C-C is fixed on first transparent substrate 31.

Namely, the top face of FPC 52 is, as shown in FIG. 4, bonded to projection portion 32A of second transparent substrate 32 via anisotropic electrically conductive film 56 using thermocompression and wiring pattern 53 on the side of the top face of FPC 52 is electrically connected to an exposed end portion of wiring/electrode pattern 42 drawn in projection portion 32A.

The bottom face of FPC 52 is, as shown in FIG. 5, bonded to projection portion 31A of first transparent substrate 31 via anisotropic electrically conductive film 57 using thermocompression. Wiring pattern 54 on the side of the bottom face of FPC 52 is electrically connected to an exposed end portion of wiring/electrode pattern 38 extended to projection portion 31A.

Polarizing plate 50 (sheet member) made of a film formed in a rectangular shape is laminated by adhesive layer 58 on an entire surface of second transparent substrate 32 excluding an area of projection portion 32A to which the FPC is thermocompression bonded.

On the top face of polarizing plate 50, hard coat layer 51 is provided by acrylic resin type coating.

Since other structural portions are same as in Embodiment 1, no description is made thereon.

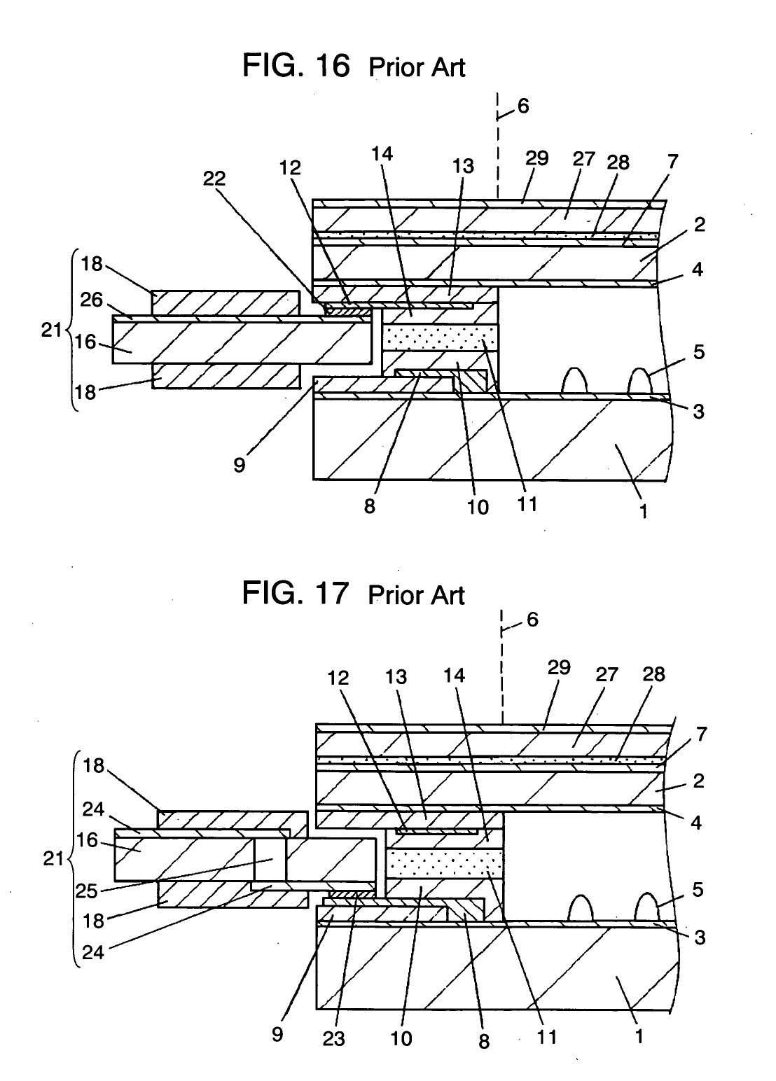

Touch panel 103 in Embodiment 2 having such structure as described above has projection portions 31A and 32A and is bonded in a compression manner with FPC 52 which has no cut in such portions as described above. Now, a shape in a side portion of each of substrates 31 and 32 to which FPC 52 is bonded using thermocompression is described in comparison with a conventional example. In a conventional touch panel as shown in FIGS. 15 to 17, one side thereof with which the FPC is bonded in a compression manner requires size H0 of length for compression bonding of the FPC as a whole, while, in touch panel 103 according to the present Embodiment 2, an area corresponding to size H02 of the length is eliminated in a side excluding a compression bonding area. For example, since a structure of a small picture frame which attains a reduction of an area corresponding to size H03=3 mm of the length can be realized, even in an apparatus on which the touch panel is mounted, reduction of a production costs and of a size a portion on which the touch panel is mounted can be realized as in Embodiment 1.

Since touch panel 103 according to the Embodiment 2 has a structure such that, not only thermocompression bonding of FPC 52 is performed within the areas of projection portions 31A and 32A, but also lamination of polarizing plate 50 is not performed within the areas of projection portions 31A and 32A, stress to be caused by curling or expansion/contraction of polarizing plate 50 under a high temperature atmosphere, a high temperature and high humidity atmosphere or at the time of a thermal shock test is allowed to give no influence on a thermocompression bonded portion of FPC 52 and, accordingly, the compression boded portion of FPC 52 is allowed to be stable in an electric connection property and excellent in environmental resistance features.

Since electrical connection stability of the compression bonded portion of FPC 52 can be secured without laminating other members for curling prevention to polarizing plate 50, cost increasing factors are reduced and the touch panel excellent in the performances and low in cost can be obtained.

Environmental resistance performances of the touch panel of Embodiment 2 were evaluated. Details of tests are as follows:
(1) Shelf test for 1000 hours or more under a high temperature and high humidity atmosphere of 60° C. 95% RH;
(2) Shelf test for 1000 hours or more under a high temperature atmosphere of 85° C.; and
(3) Thermal shock test repeating 1000 times or more a cycle of leaving for 30 minutes at −40° C. and leaving 30 minutes at 85° C.

After these tests, in the touch panel according to the present Embodiment 2, failures of the electric connection did not occur. Further, after (4) shelf test for 1000 hours under a high temperature and high humidity atmosphere of 85° C. 85% RH, functions of the touch panel was normal.

Since the touch panel according to the present Embodiment has a structure such that polarizing plate 50 is laminated on the surface of the touch panel, a reflectivity was about 8% when light having a wavelength of 550 nm was used. In an example of the conventional touch panel having no polarizing plate, the reflectivity was about 14% and, accordingly, the touch panel according to the present Embodiment was able to reduce the reflectivity by half.

As described above, touch panel 103 according to Embodiment 2 has a structure such that FPC 52 is interposed between projection portion 31A of first transparent substrate 31 and projection portion 32A of second transparent substrate 32. Since it is further structured such that polarizing plate 50 is laminated on the top face portion of second substrate 32 excluding projection portion 32A on which FPC 52 was thermocompression bonded, reduction of the size and weight of the touch panel can be realized and, also, it can contribute to reduction of the size and weight of the apparatus on which it is mounted. Furthermore, including a case in which FPC 52 is bonded using thermocompression to both first transparent substrate 31 and second transparent substrate 32, since FPC 52 is excellent in the electric connection property, the touch panel which can be used in such application as being mounted on a car which requires severe environmental resistance features can easily be realized.

In place of polarizing plate 50, a circularly polarizing plate which has a quarter-wave plate made of an oriented polycarbonate film or polyolefin film laminated on the polarizing plate via adhesives can be also used. The circularly polarizing plate having adjusted phase difference can be also bonded as a sheet member on a top face portion of second transparent substrate 32 excluding the area of projection portion 32A.

On this occasion, although it is necessary to laminate another quarter-wave plate polarizer for optical compensation on a bottom face of first transparent substrate 31 or on a top face of a liquid crystal device for the purpose of adjusting the phase difference of light emitted from the liquid crystal device, the touch panel having reflectivity of 5% can be realized and can further reduce a reflection of light incident to the touch panel from outside.

Even in this case, a hard coat layer is preferably provided on a surface of the circularly polarizing plate.

In a case in which the polarizing plate or the circularly polarizing plate is laminated on second transparent substrate 32, a reflection of external light can further be reduced by providing an anti-reflection layer on a top face of hard coat layer 51, regardless of using the polarizing plate or the circularly polarizing plate.

As the sheet member besides polarizing plate 50, or the circularly polarizing plate, an anti-reflection film, a hard coat film, a colored film, a resin sheet of an indication label formed by, for example, printing an input key indication or a pattern display, or the like may be laminated on the top face portion of second transparent substrate 32 excluding the area of projection portion 32A. Since functions corresponding to the sheet member to be laminated are added to the touch panel, the touch panel excellent in electric connection stability and the like can be obtained.

In these sheet members including the polarizing plate and the circularly polarizing plate, a plurality of sheets may be laminated with one another.

As for polarizing plate 50, a conventional polarizing film which has a structure by interposing a polarizer which is formed by first dispersing any one of iodine and a dye in a polyvinyl alcohol film, orienting the resultant film, and then sandwiched by triacetyl cellulose films is preferred. That polarizer is mainly used in a liquid crystal display device. On this occasion, at the time of laminating the polarizing film, it is important to align an oriented axis with a polarizing axis of the liquid crystal display device provided under the touch panel.

As for the anti-reflection layer, an anti-reflection film made of a coated fluorocarbon resin, or the film made of a single layer or a plurality of layers having a low refractive compound such as SiO₂ or MgF or a high refractive compound such as TiO₂ or ZrO₂ formed by, for example, sputtering or vacuum deposition can be used. Further, a hard coat layer may be formed between the anti-reflection layer and the film.

The hard coat film or the colored film is formed from acrylic resin coating solution or the acrylic resin coating solution dispersed with pigments by using a roll coater or the like. Further, an indication label is formed from a resin ink of polyester, polyurethane or polyacrylate dispersed with pigments by a screen printing and formed in a predetermined pattern.

A structure of laminating the sheet member on an area excluding the area of the projection portion to which the FPC is bonded using thermocompression can be applied to the structure of the touch panel according to Embodiment 1 and a same effect can be expected.

### Embodiment 3

With reference to Embodiment 3, a liquid crystal display device attached with touch panel (hereinafter, referred to also as “TTP-LCD”) 106 in which touch panel 61 as described in Embodiment 1 is mounted on a liquid crystal display device is described below. Parts having same structures as those in Embodiment 1 are marked with same references and will not be described in detail.

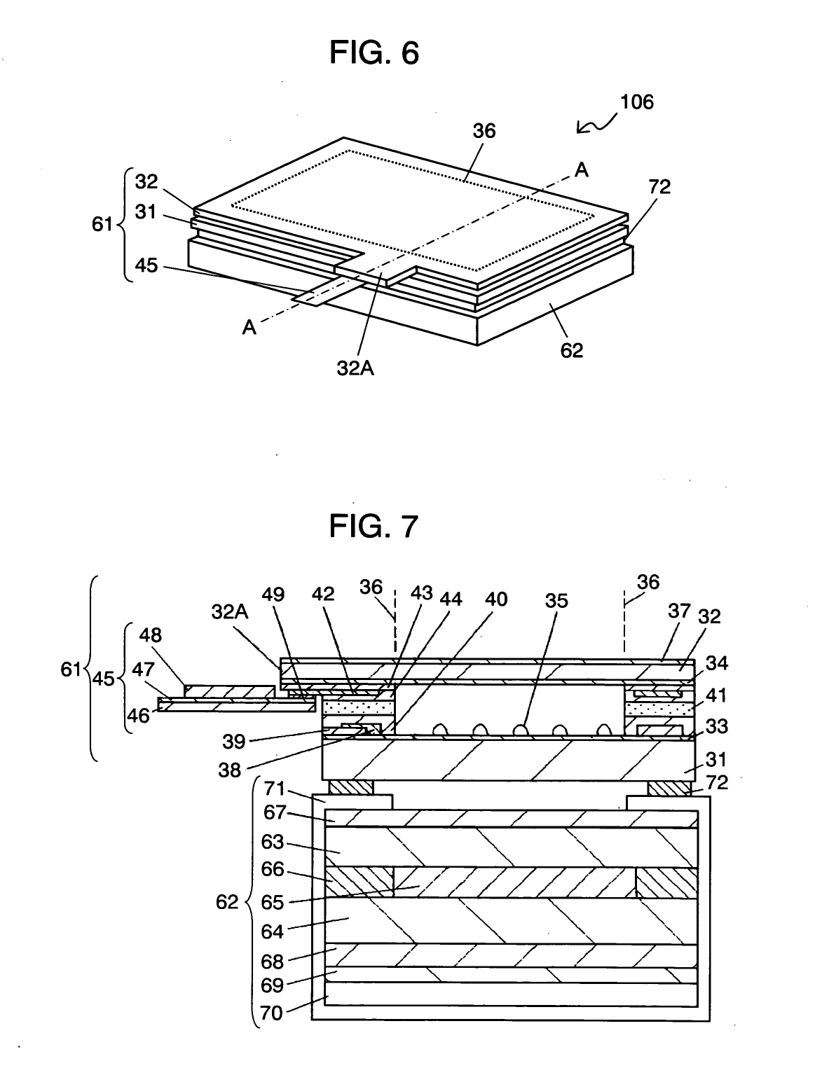

FIGS. 6 and 7 are views explaining TTP-LCD 106 according to Embodiment 3 of the present invention, in which touch panel 61 is provided on a display screen of liquid crystal display device 62.

Liquid crystal display device 62 includes upper substrate 63, lower substrate 64, liquid crystal layer 65, seal layer 66, upper polarizing plate 67, lower polarizing plate 68, light guide plate 69, backlight 70, and case bezel 71.

In FIG. 6, other components involved in liquid crystal display device 62, for example, a circuit substrate for liquid crystal display drive or various types of semiconductors or passive components mounted thereon, a flexible printed-circuit board from upper substrate 63 or lower substrate 64 to the circuit substrate and a diffuser for the backlight are not shown.

Touch panel 61 is mounted such that a bottom face of soda glass which is first transparent substrate 31 of touch panel 61 is bonded in a frame state on case bezel 71 of liquid crystal display device 62 via pressure sensitive adhesive double coated tape 72.

Since an external shape of a rectangular shape portion of touch panel 61 of embodiment 1 is small, it is possible to use liquid crystal display device 62 having a small external shape in correspondence with that of the rectangular shape. By taking such structure as described above, touch panel 61 can contribute to reduction of size, weight or cost of an apparatus on which TTP-LCD 106 is mounted and, further, to simplification of design of an interior structure along with the reduction of size and weight.

So long as the size of the external shape of the rectangular portion excluding projection portion 32A of touch panel 61 is same with or smaller than that of a rectangle of liquid crystal display device 62, same effect of reduction of the size, weight or the like of an apparatus to be caused by the reduction of touch panel 61 can be expected.

As for liquid crystal display device 62, a case of transmission type liquid crystal display device having a backlight has been explained; however, this invention can be applied to a reflection type liquid crystal display device having a front light, a reflection type liquid crystal display device having no light source or a semi-transmission type liquid crystal apparatus having the backlight.

As for the method of establishing a combination of touch panel 61 and liquid crystal display device 62, a method, as described above, of bonding touch panel 61 by using pressure sensitive adhesive double coated tape 72, a method in which positions of touch panel 61 and liquid crystal display device 62 are only aligned with each other without using the tape or the like and, then, they are pressed with each other by an outer packaging case or the like, a method in which they are placed not on the bezel of the liquid crystal display device but on display glass or the like may be used.

### Embodiment 4

With reference to Embodiment 4, a liquid crystal display device attached with touch panel (hereinafter, referred to also as “TTP-LCD”) 108 in which the touch panel according to Embodiment 2 is mounted on a liquid crystal display device is described below. Same components in the touch panel as those in Embodiment 2 are marked with same references and will not be described in detail. Further, parts having same structures in the liquid crystal display device as those explained in Embodiment 3 are marked with same references and will not be described in detail.

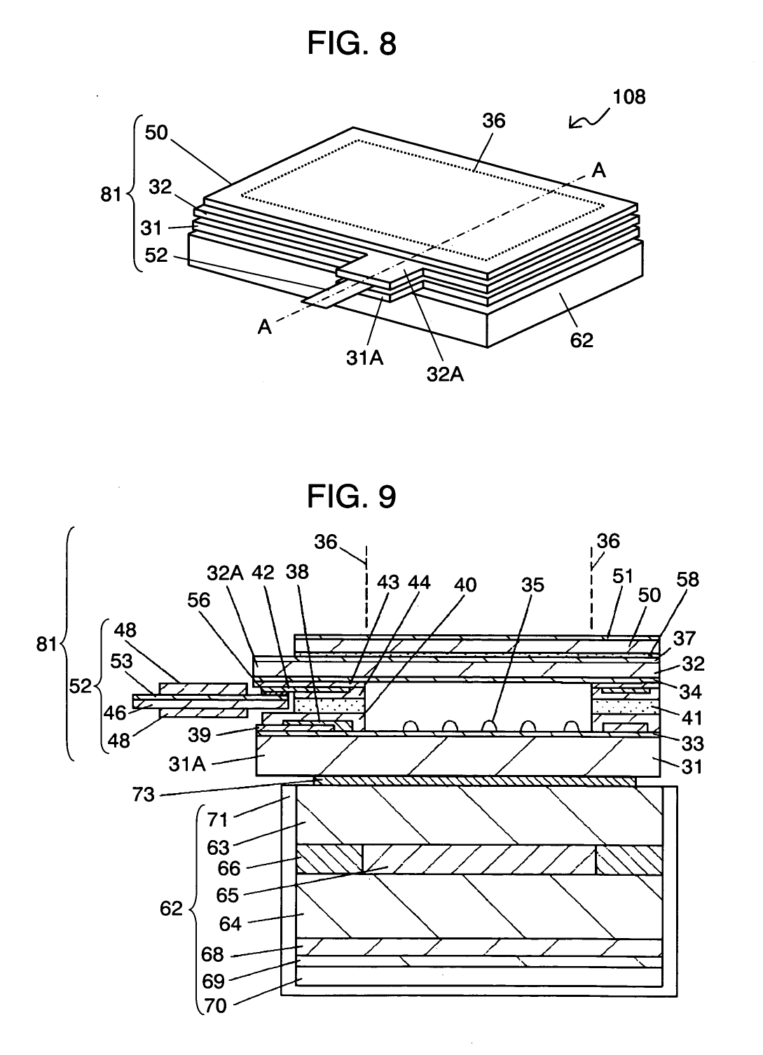

FIGS. 8 and 9 are views explaining TTP-LCD 108 according to Embodiment 4 of the present invention.

In TTP-LCD 108, touch panel 81 as described in Embodiment 2 is mounted such that an entire face thereof inside visible area boundary 36 on the bottom face of first transparent substrate 31 is bonded on the top face of liquid crystal display device 62 within the display area thereof via transparent pressure sensitive tape 73. On this occasion, an upper polarizing plate is not provided on liquid crystal display device 62.

At this time, since touch panel 81 is formed with a narrow picture frame having a small external shape of an approximately rectangular shape excluding projection portions 31A and 32A, it is possible to use liquid crystal display device 62 having a smaller external shape in correspondence with the external shape of the picture frame in a same manner as in Embodiment 3.

Further, since touch panel 81 has a structure such that an area in projection portion 32A on which FPC 52 is bonded using thermocompression is not provided with polarizing plate 50, a small-sized light-weight TTP-LCD in which FPC 52 is excellent in electric connection stability and the like can be obtained.

TTP-LCD 108 is in a state in which touch panel 81 having polarizing plate 50 on a surface thereof and liquid crystal display device 62 are bonded with each other via transparent pressure sensitive adhesive double coated tape 73 in a shape corresponding to a display area of liquid crystal display device 62. For this account, light reflection in the display area can be reduced. A measured reflectivity of TTP-LCD 108 is approximately 6% by light having a wavelength of 550 nm and a lower reflection than that of a conventional example in which the touch panel and the liquid crystal display device are not bonded with each other was able to be realized.

As for the reason why the reflectivity of the TTP-LCD was able to be low, it can also be mentioned as that liquid crystal display device 62 has a structure without using an upper polarizing plate. Namely, since the TTP-LCD has a structure in which the number of the polarizing plates is smaller by one as a whole, a degree of light reflection can be reduced, brightness of the liquid crystal display is enhanced and, also, visibility thereof comes to be excellent.

Further, touch panel 81 which is bonded to liquid crystal display device 62 on an entire face of the display area can be constituted by comprising, in place of polarizing plate 50, a circularly polarizing plate in which a quarter-wave plate polarizer is bonded on a bottom face of the polarizing plate and, also, a quarter-wave plate polarizer for the purpose of optical compensation is bonded on a bottom face of first transparent substrate 31 or a top face of liquid crystal display device 62. By taking this structure, the reflectivity of the TTP-LCD can be reduced to approximately 3%.

Also on this occasion, it is effective that the hard coat layer is provided on the surface of the circularly polarizing plate.

In the aforementioned structure, touch panel 81 was bonded in a state in which the upper polarizing plate of liquid crystal display device 62 was removed; however, it is also possible that touch panel 81 is bonded in a state in which the upper polarizing plate is provided. On this occasion, since the polarizing plate is provided on the top face of liquid crystal display device 62 by double, brightness of the display is slightly reduced compared with that from which the upper polarizing plate is removed; however, it has a structure such that it has same effect in reducing the reflection of external light as in the previous case.

Further, as described in Embodiment 2, touch panel 81 may have an anti-reflection film, a hard coat film, a colored film, a resin sheet of an indication label formed by, for example, printing an input key indication or a pattern display which is fixed on a whole surface or a part of the surface of the touch panel. On this occasion, a plurality of films including the polarizing plate and circularly polarizing plate may be laminated with each other.

Liquid crystal display device 62 as shown in FIG. 9 shows an example of a transmission type liquid crystal display device having a backlight; however, this invention can be applied to a reflection type liquid crystal display device having a front light, a reflection type liquid crystal display device having no light source or a semi-transmission type liquid crystal apparatus having the backlight.

As has been described, since the touch panel according to the present invention has a structure such that the thermocompression bonding of the FPC is performed in the projection portion, width of the picture frame excluding the projection can be small. When the touch panel is further constituted such that the sheet member is allowed to be provided only on the top face portion of the second transparent substrate excluding the projection portion, the touch panel which is imparted with functions of the sheet member, is excellent in environmental resistance features and is low in cost can be realized. The thus-realized touch panel can contribute to reduction of the size and weight of the apparatus on which the touch panel is mounted and is useful in widening applications of the touch panel up to a field which requires severe usage environment such as mounting on a car.

1. A touch panel, comprising:
a first transparent substrate having a first transparent electrically conductive film;
a second transparent substrate having a second transparent electrically conductive film provided on a face opposite to the first transparent electrically conductive film;
an outer circumferential portion for bonding the first transparent substrate and the second transparent substrate while maintaining a specified space therebetween; and
a flexible printed-circuit board (FPC) bonded using thermocompression to at least one of the first transparent substrate and the second transparent substrate, and connected to the first transparent electrically conductive film and the second transparent electrically conductive film,
wherein at least one of the first transparent substrate and the second transparent substrate has a projection portion and the FPC is fixed to the projection portion.

2. The touch panel as set forth in claim 1, wherein the first transparent substrate and the second transparent substrate have rectangular portions, and at least one of the first transparent substrate and the second transparent substrate has the projection portion having a specified width and a specified projection distance.

3. The touch panel as set forth in claim 1, wherein the second transparent substrate is a plastic film and comprises a rectangular portion and the projection portion; and the FPC is fixed to the projection portion of the second transparent substrate.

4. The touch panel as set forth in claim 3, further comprising a sheet member bonded to the rectangular portion of the second transparent substrate, the sheet member is selected from the group consisting of a polarizing plate, a circularly polarizing plate, an anti-reflection film, a hard coat film, a colored film and an indication label.

5. The touch panel as set forth in claim 1, wherein the first transparent substrate and the second transparent substrate are plastic films and both have a rectangular portion and a projection portion, and the projection portion of the first transparent substrate and the projection portion of the second transparent substrate face each other with the FPC between.

6. The touch panel as set forth in claim 5, wherein
a first part of the FPC is fixed to the projection portion of the the first transparent substrate,
a second part of the FPC is fixed to the projection portion of the second transparent substrate,
the first part and the second part does not overlap each other, and
no cut is provided between the first part and the second part.

7. The touch panel as set forth in claim 5, further comprising a sheet member bonded to the rectangular portion, wherein the sheet member is selected from the group consisting of a polarizing plate, a circularly polarizing plate, an anti-reflection film, a hard coat film, a colored film and an indication label.

8. The touch panel as set forth in claim 1, wherein the FPC is fixed over an entire width by thermocompression to a projection portion provided on the second transparent substrate.

9. A liquid crystal display apparatus comprising:
a touch panel comprising a rectangular portion made of a transparent substrate, a projection portion projecting from one side of the rectangular portion and an FPC fixed to the projection portion; and
a liquid crystal display device,
wherein the touch panel is disposed on the liquid crystal display device; and a size of the rectangular portion of the touch panel is same with or smaller than a size of an external shape of the liquid crystal display device.

10. The liquid crystal display apparatus as set forth in claim 9, further comprising a transparent adhesive layer covering an entire surface of a display portion of the liquid crystal display device, wherein a rectangular portion of the touch panel and the liquid crystal display device are bonded to each other via the adhesive layer.

11. The liquid crystal display apparatus as set forth in claim 10, wherein the liquid crystal display device has a polarizing plate on a face facing to the touch panel.

12. The liquid crystal display apparatus as set forth in claim 10, further comprising a polarizing plate or a circularly polarizing plate bonded to the rectangular portion, wherein the rectangular portion of the touch panel and the liquid crystal display device are bonded to each other.

13. The liquid crystal display apparatus as set forth in claim 12, wherein a transparent substrate of the touch panel and a transparent substrate of the liquid crystal display device are bonded with each other by the adhesive layer.
